(19) United States
(12) Patent Application Publication
(10) Pub. No.: US 2014/0184651 A1
(43) Pub. Date: Jul. 3, 2014

(54) DISPLAY DEVICE AND CONTROL METHOD OF DISPLAY DEVICE

(71) Applicant: Kabushiki Kaisha Toshiba, Tokyo (JP)

(72) Inventors: Tatsuo SAISHU, Tokyo (JP); Yoshiharu MOMONOI, Yokohama (JP); Takahisa KAIHOTSU, Tokyo (JP); Yasunori MAKI, Iruma (JP); Tooru MIYAZAKI, Tokyo (JP)

(73) Assignee: Kabushiki Kaisha Toshiba, Tokyo (JP)

(21) Appl. No.: 14/189,717

(22) Filed: Feb. 25, 2014

Related U.S. Application Data
(63) Continuation of application No. PCT/JP2013/058405, filed on Mar. 22, 2013.

(30) Foreign Application Priority Data
Dec. 27, 2012 (JP) 2012285885

(51) Int. Cl. G06T 3/40; G02B 3/08; G02B 27/02

(52) U.S. Cl. CPC G06T 3/40; G02B 27/027; G02B 3/08
USPC 345/660; 359/804; 359/742

(57) ABSTRACT

According to one embodiment, a display device includes a bezel, a display, and a transparent lens member. The display includes a display screen surrounded by the bezel. The transparent lens member is arranged in front of the bezel and the display screen so as to cover at least the display screen, and is capable of displaying an image displayed on the display screen in an enlarged manner of a size equal to or larger than an outer shape of the bezel. The transparent lens member includes an anisotropic magnification lens portion and a non-lens portion. The anisotropic magnification lens portion is provided to a periphery of the transparent lens member. The non-lens portion has a flat plate configuration and is arranged at a center portion of the transparent lens member.

### CROSS-REFERENCE TO RELATED APPLICATIONS

This application is a continuation of International Application No. PCT/JP2013/058405, filed Mar. 22, 2013, which designates the United States, incorporated herein by reference, and which is based upon and claims the benefit of priority of the Japanese Patent Application No. 2012-285885, filed Dec. 27, 2012, the entire contents of which are incorporated herein by reference.

### FIELD

Embodiments described herein relate generally to a display device and a control method of a display device.

### BACKGROUND

Conventionally, there has been known a display device that uses a liquid crystal display panel, a plasma display panel, and an electroluminescent display panel.

Every year, a size of such display device tends to increase, but to the contrary, it has been desired to reduce a width of a bezel provided to a periphery of a display screen.

However, according to the conventional technique, although the width of the bezel has begun to be reduced, such bezel cannot be removed completely because of the point of view of configuration and strength.

In particular, in a multi-display system configured by arranging a plurality of display devices in a matrix, the bezel is ended up being arranged between the displays.

Accordingly, even if the width of the bezel is decreased, there still exists a black line having twice the width of the bezel on the display screen. Thus, such situation is not preferred in terms of visual appearance.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary diagram (plan view) for explaining a schematic configuration a display device according to a first embodiment;

FIG. 1B is an exemplary schematic cross-sectional view of the display device in the first embodiment;

FIG. 2 is an exemplary flowchart of an image displaying process according to a second embodiment;

FIG. 3A is an exemplary diagram (plan view) for explaining a schematic configuration of a display device in the second embodiment;

FIG. 3B is an exemplary general cross-sectional view of the display device in the second embodiment; and

FIG. 4 is an exemplary diagram for explaining a schematic configuration of a display device according to a third embodiment.

### DETAILED DESCRIPTION

In general, according to one embodiment, a display device comprises a bezel, a display, and a transparent lens member. The display comprises a display screen configured to be surrounded by the bezel. The transparent lens member is configured to be arranged in front of the bezel and the display screen so as to cover at least the display screen, and to be capable of displaying an image displayed on the display screen in an enlarged manner of a size equal to or larger than an outer shape of the bezel. The transparent lens member comprises an anisotropic magnification lens portion and a non-lens portion. The anisotropic magnification lens portion is provided to a periphery of the transparent lens member. The non-lens portion has a flat plate configuration and arranged at a center portion of the transparent lens member.

Various embodiments will be described hereinafter with reference to the accompanying drawings.

### FIRST EMBODIMENT

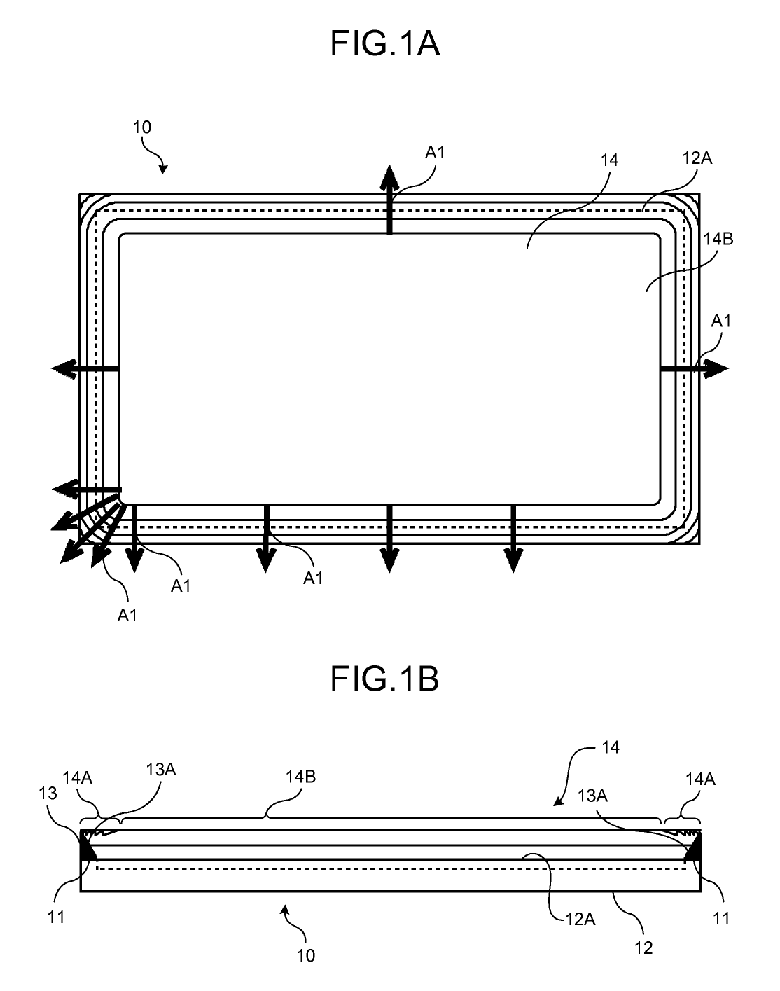

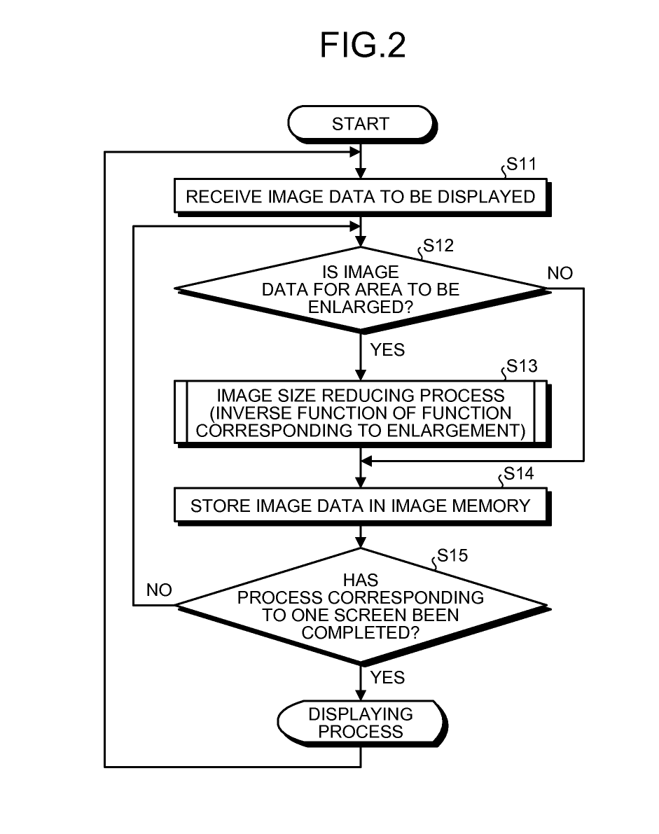

FIG. 1A is a diagram (plan view) for explaining a schematic configuration of a display device according to a first embodiment.

FIG. 1B is a schematic cross-sectional view of the display device in the first embodiment.

This display device 10 generally comprises a display 12 and a transparent lens member 14. The display 12 comprises a bezel 11. The transparent lens member 14 is supported at a predetermined position in front of a display screen 12A by a support 13 so as to cover the bezel 11 of the display 12 and the display screen 12A, as illustrated in FIG. 1.

A face 13A of the support 13 abutting against the transparent lens member 14 may be a reflective surface. The support 13 may be a transparent member that is integrated with the transparent lens member.

The peripheral portion of the transparent lens member 14 is configured as a linear Fresnel lens portion 14A having a linear Fresnel lens configuration. The central portion of the transparent lens member 14 is configured as a non-lens portion 14B having a flat plate configuration. This linear Fresnel lens is a configuration provided only on one side of the principal axis (magnification center) of the lens, and is connected continuously to the non-lens portion at the principal axis of the lens or near the principal axis of the lens.

Upon assumption that a linear Fresnel lens employs a Fresnel lens of a regular plano-convex cylindrical lens, a shape of the linear Fresnel lens portion 14A in the plan view of the groove is rectangular with four corners being rounded, unlike the mere rectangular shape in the plan view of the groove.

As a result, the magnifying direction changes continuously along the entire circumference, unlike a linear Fresnel lens in which the magnifying direction changes abruptly at the four corners.

The linear Fresnel lens portion 14A and the non-lens portion 14B are also continuously provided. The non-lens portion 14B also has a rectangular shape whose four corners are rounded, when the non-lens portion 14B is viewed from the top.

The center of magnification of the linear Fresnel lens portion 14A extends along the sides of the non-lens portion 14B.

That is to say, each of a plurality of grooves of the linear Fresnel lens portion 14A forms a shape (closed loop shape) of rectangle with its four corners rounded. Such configuration ensures the distance between one groove and another groove adjacent thereto to be kept constant across the entire circumference.

Therefore, the innermost circumference of the linear Fresnel lens portion 14A also has a shape of rectangle with its four corners being rounded. In the same manner, the linear Fresnel lens configuration itself also has a closed-loop shape of rectangle with its corners being rounded. Hence, the magnifying direction extends perpendicular to the sides of this approximate rectangular shape whose four corners are rounded.

As a result of such configuration, the center of magnification of the linear Fresnel lens portion 14A comes to be positioned at the proximal end of the arrow A1, and the direction of the arrow A1 indicates the magnifying direction. In other words, the linear Fresnel lens portion 14A functions as an anisotropic magnification lens having a loop-shaped magnification center extending near the sides of the display screen 12A of the display 12, at positions facing the display screen 12A.

The center of magnification of the linear Fresnel lens portion 14A is positioned nearer to the center of the display screen 12 than the positions facing the peripheral portions of the display screen 12A.

Therefore, the image at the peripheral portions of the display screen 12A is displayed in an enlarged manner by the linear Fresnel lens portion 14A, and the magnifying direction in the peripheral portions is configured to shift continuously, as described above.

Because the linear Fresnel lens portion 14A of the transparent lens member 14 has a linear Fresnel lens configuration, the image is hardly or is not enlarged at all in a direction perpendicular to the arrow A1.

Furthermore, the image at the center of the display screen 12A simply passes through the non-lens portion 14B, thereby displayed in its original size.

Therefore, an image to be displayed at the peripheral portions of the display screen 12A, that is, an image to be displayed in an enlarged manner by the linear Fresnel lens portion 14A, is ensured to be continuous with the image at the center. In other words, the image displaying is performed at the size reduced by a reduction ratio of the inverse of the magnification ratio so that the normal image is displayed when it is enlarged.

When the linear Fresnel lens portion 14A and the non-lens portion 14B are different in thickness, the transmittance becomes different as well. Therefore, the images at the positions facing the linear Fresnel lens portion 14A are provided with different luminance from that of positions facing the non-lens portion 14B, so that uniform luminance is achieved across the entire images transmitted through these portions. Specifically, the luminance ranges of the image signals or the luminance of the backlight are adjusted.

A displaying process according to the first embodiment will now be explained.

It is assumed herein that display image data of an image that is to be displayed on the display device 10 is received from an external image reproducing device (e.g., a recorder, a tuner, or a personal computer).

When the display device 10 receives display image data corresponding to one screen from the external image reproducing device (S11), the controller, not illustrated, of the display device 10 analyzes the image data making up the image data to be displayed (for example, image data in units of one pixel), and determines if the image data is for an area to be enlarged by the linear Fresnel lens portion 14A (S12).

If the image data is determined not to be data for an area to be enlarged in the determination at S12 (No at S12), the controller, not illustrated, of the display device 10 causes the process to transition to S14.

If the image data is determined to be data for an area to be enlarged in the determination at S12 (Yes at S12), the controller, not illustrated, of the display device 10 reduces the image by the reduction ratio of equal to the inverse of the magnification ratio, and performs an image size reducing process with an inverse function taking into account the image deformation due to the magnification and/or the image position for securing the continuity (S13).

As a result, the controller, not illustrated, of the display device 10 stores the image data displayed at the position corresponding to the position of the non-lens portion 14B as it is in the image memory not illustrated (e.g., a video random access memory (VRAM)), whereas the image data displayed at the position corresponding to the position of the linear Fresnel lens portion 14A is applied with the image size reducing process and is stored in a manner having its size reduced in the image memory not illustrated (S14).

The controller, not illustrated, of the display device 10 then determines if the process corresponding to one screen has been completed (S15).

If the process for one screen is determined not to have been completed yet in the determination at S15, the process is transitioned to S12 again, and the same process is repeated subsequently.

If the process corresponding to one screen is determined to have been completed in the determination at S15 (Yes at S), the controller, not illustrated, of the display device 10 causes the display screen in the display 12 to display the image stored in the image memory, causes the process to transition to S11 again, and repeats the process until the image data to be displayed is no longer received.

As a result of this process, an image is displayed on the display screen of the display 12 in such a manner that the bezel 11 of the display 12 cannot be seen.

In the description above, the image data is explained to be received in units of data corresponding to one screen. However, the process is performed in the same manner when the image data is received in units of data corresponding to a plurality of screens. Furthermore, used in the description above is an example in which the resolution (number of pixels) of an input image to be displayed is the same as that of an output image. However, when the resolutions of an input image and an output image are different, it is possible to perform a partial image reduction process in addition to the regular scaling process for the entire screen.

As explained above, according to the first embodiment, the bezel of a display device can effectively be made invisible when the display device is viewed from predetermined viewing positions.

In the description above, the display device 10 is explained to be a single device. Here, the display device 10 can be function as a display device having no bezel, in effective manner. Thus, it is also possible to build a multi-display system (tiling display system) by arranging a plurality of display devices 10 in an n×m matrix.

Because the multi-display system using the display device 10 according to the first embodiment has no bezel in effective manner, it is possible to provide the display screens almost seamlessly as compared to the case of a traditional display device (display). Consequently, a more expressive larger screen display can be achieved.

### SECOND EMBODIMENT

In the first embodiment, the transparent lens member is explained to comprise a linear Fresnel lens configuration. In a second embodiment, the entire surface of the transparent lens member is provided with a Fresnel lens configuration.

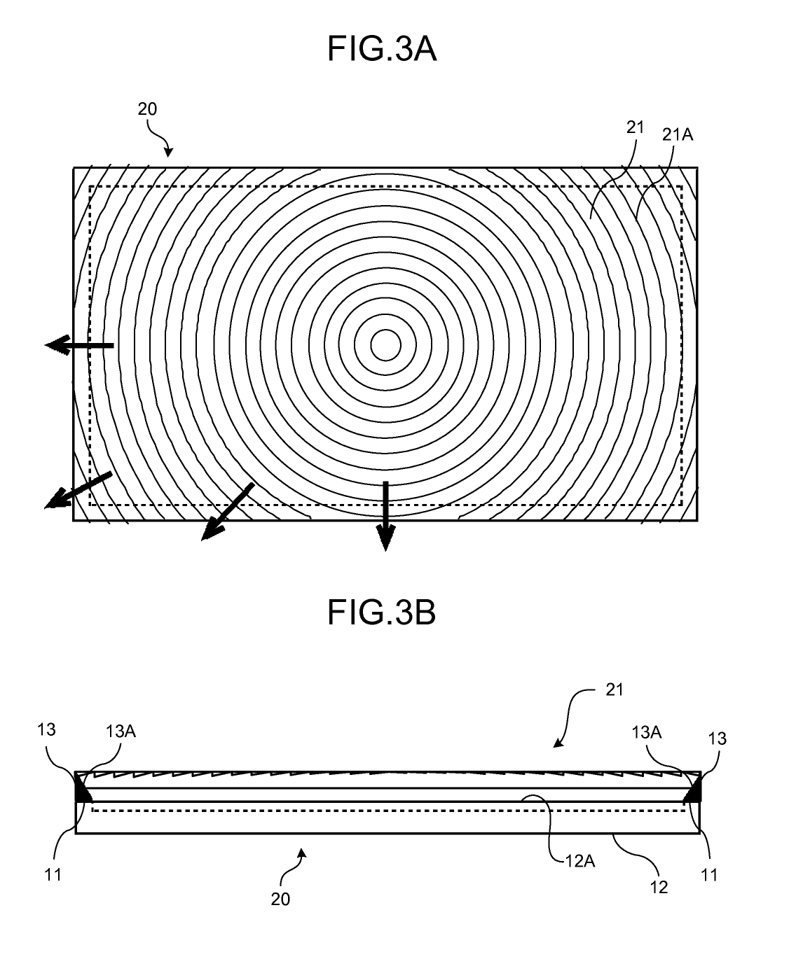

FIG. 3A is a schematic diagram (plan view) for generally explaining a display device in the second embodiment.

FIG. 3B is a general cross-sectional view of the display device in the second embodiment.

A transparent lens member 21 in a display device 20 is provided with a Fresnel lens portion 21A having a concentric Fresnel lens configuration across the entire front side surface.

Because the entire transparent lens member 21 according to the second embodiment functions as a convex lens, the entire image displayed on the display screen is enlarged. Therefore, image processing does not need to be applied to an image to be displayed, unlike in the first embodiment.

However, there are some cases in which transmittance still varies, in the same manner as in the first embodiment, because of the difference in thickness of or scattering in the Fresnel lens surface. Therefore, in order to acquire even luminance across the entire surface after the image passes through the transparent lens member 21, it is necessary to adjust the luminance of the image to be displayed on the display screen. Specifically, the luminance ranges of the image signals or the luminance of the backlight are adjusted.

As described above, according to the second embodiment, a display device in which a bezel is removed in effective manner can be achieved, in the same manner as in the first embodiment. Furthermore, even when a multi-display system is built, it is possible to provide the display screens almost seamlessly, so that a more expressive larger monitor display can be achieved.

### THIRD EMBODIMENT

In a third embodiment, the transparent lens member is provided while suppressing a thickness increase and ensuring high resolution of the display.

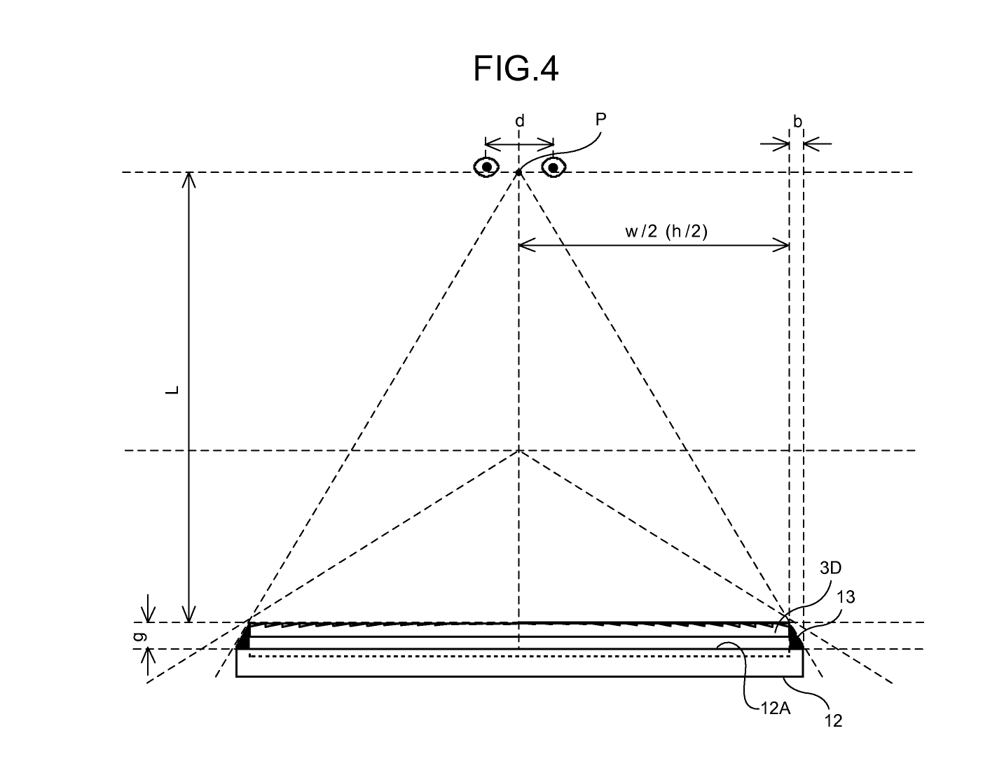

Therefore, a transparent lens member that is the same as the transparent lens member 14 according to the first embodiment or that is the same as the transparent lens member 21 according to the second embodiment maybe used as a transparent lens member according to the third embodiment. FIG. 4 illustrates a case when a transparent lens member 30 that is the same as the transparent lens member 21 according to the second embodiment is provided.

In order to achieve the objectives mentioned above, in the third embodiment, a standard viewing distance L that is a distance from the display screen 12A to a standard viewing position P is set to 1.5 times to 7 times of the height h of the display screen (=1.5*h to 7*h). The outer shape of the transparent lens member 30 is then set in such a manner that, when such an outer shape is projected onto a plane comprising the display screen 12A, the outer shape of the transparent lens member 30 thus projected becomes larger than the size of the bezel of the display, and that the aspect ratio of the transparent lens member 30 becomes smaller than that of the display area of the display screen.

When the aspect ratio of the transparent lens member 30 is the same as that of the display area of the display screen, the bezel could become visible on the right side or the left side of the display device, or the image on the top edge or the bottom edge could be cut off, due to the difference in the positions of the right and the left eyes of a viewer.

Therefore, when the configuration described above is to be used, the following dimensional relation needs to be satisfied.

FIG. 4 is a schematic diagram for explaining a relation between the size of the transparent lens member and the size of the bezel in the display device in the third embodiment .

The height of the display screen (display area) is denoted by h, and the width of the display screen (display area) is denoted by w. The standard viewing distance is denoted by L (=1.5h to 7h), and the width of the bezel (the distance from the outer edge of the display screen to the outer edge of the display area) is denoted by b. The distance from the front surface (pixel surface) of the display screen of the display device to the front surface (lens surface) of the transparent lens member is denoted by g. An inter-eye distance d that is a distance between the eyes of a standard viewer is assumed to be 60 millimeters to 70 millimeters.

Under these assumptions, in order to prevent the bezel from becoming visible on the right side or the left side of the display device and to prevent the image on the top edge or the bottom edge from being cut off regardless of variations in the eye positions of viewers, the aspect ratio (width and height ratio) of the transparent lens member 30 can be configured to be longer in the lateral direction (width direction), in comparison with that of the display screen, by a several percent.

More specifically, the horizontal size and the vertical size may be set to satisfy the following Equation (1) and Equation (2), respectively:

(w/2−d/2)/b≧L/g (1)

(h/2)/b≧L/g (2)

It is also possible to use different magnification ratios or areas to be magnified on the top side and the bottom side, and on the right side and the left side of the transparent lens member 30 as required, when the top side, the bottom side, the right side, and the left side of the bezel have different widths, or depending on the height of assumed viewers.

As described above, according to the third embodiment, not only the advantageous effects achieved by the first embodiment or the second embodiment are achieved, but the bezel can also be prevented from becoming visible on the right side or the left side of the display device, or an image from being cut off at the top edge or the bottom edge due to the difference in the positions of the right and the left eyes of a viewer. Furthermore, according to the third embodiment, the bezel of a display device can be made invisible in effective manner when the display device is viewed from predetermined viewing positions, without preventing the display device from being reduced in size.

### MODIFICATIONS OF EMBODIMENTS

In the description above, an effect of a parallax, caused by the thickness of the transparent lens member and differences in the positions of a user with respect to the display device, is not taken into consideration. It is also possible to provide the display device with an image acquiring device such as a camera, to allow the image acquiring device to track the user so that the position of the user can be detected, and to correct the image to be displayed so as to reduce the effect of the parallax that is dependent on the user position.

A control program executed by the display device according to the embodiment is provided in a manner recorded in a computer-readable recording medium, such as a compact disk read-only memory (CD-ROM), a flexible disk (FD), a compact disk recordable (CD-R), or a digital versatile disk (DVD), as a file in an installable or executable format.

Furthermore, the control program executed by the display device according to the embodiment may be stored in a computer connected to a network such as the Internet, and may be made available for download over the network. Furthermore, the control program executed by the display device according to the embodiment maybe provided or distributed over a network such as the Internet.

Furthermore, the control program for the display device according to the embodiment may be provided in a manner incorporated in an read-only memory (ROM), an image processing large scale integration (LSI), or the like in advance.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a bezel;
a display comprising a display screen configured to be surrounded by the bezel; and
a transparent lens member configured to be arranged in front of the bezel and the display screen so as to cover at least the display screen, and to be capable of displaying an image displayed on the display screen in an enlarged manner of a size equal to or larger than an outer shape of the bezel, wherein
the transparent lens member comprises:
an anisotropic magnification lens portion provided to a periphery of the transparent lens member; and
a non-lens portion comprising a flat plate configuration and arranged at a center portion of the transparent lens member.

2. The display device of claim 1, wherein the anisotropic magnification lens portion is configured as a linear Fresnel lens portion comprising a linear Fresnel lens configuration.

3. The display device of claim 2, wherein the linear Fresnel lens portion comprises a magnification center near a border between the linear Fresnel lens portion and the non-lens portion.

4. The display device of claim 2, wherein the linear Fresnel lens portion comprises a groove configuring the linear Fresnel lens configuration and formed in a closed-loop shape.

5. A display device comprising:
a bezel;
a display comprising a display screen configured to be surrounded by the bezel; and
a transparent lens member configured to be arranged in front of the bezel and the display monitor so as to cover at least the display screen, and to be capable of displaying an image displayed on the display screen in an enlarged manner of a size equal to or larger than an outer shape of the bezel, wherein
the transparent lens member comprises a Fresnel lens portion comprising a Fresnel lens configuration positioned on an entire front side face of the transparent lens member and functioning as a plano-convex lens.

6. The display device of claim 1, wherein,
when an outer shape of the transparent lens member is projected from a standard viewing position at a standard viewing distance from the display screen onto a plane comprising the display screen, the projected outer shape is set to be larger than the outer shape of the bezel, and
an aspect ratio of the transparent lens member is set to be smaller than an aspect ratio of the display screen.

7. The display device of claim 6, wherein,
when a height of the display screen is denoted by h, a width of the display screen is denoted by w, the standard viewing distance is denoted by L (=1.5h to 7h), a width of the bezel is denoted by b, a distance from a front surface of the display screen to a front surface of the transparent lens member is denoted by g, and an inter-eye distance of a standard viewer is denoted by d, the transparent lens member satisfies Equation (1) and Equation (2):
(w/2−d/2)/b≧L/g (1)
(h/2)/b≧L/g (2) .

8. A control method of a display device performed in a display device, the display device comprising:
a bezel,
a display comprising a display screen configured to be surrounded by the bezel, and
a transparent lens member configured to be integrated with the display and arranged in front of the bezel and the display screen so as to cover at least the display screen, and to be capable of displaying an image displayed on the display screen in an enlarged manner of a size equal to or larger than an outer shape of the bezel, the transparent lens member comprising an anisotropic magnification lens portion and a non-lens portion, the anisotropic magnification lens portion being provided to a periphery of the transparent lens member, the non-lens portion comprising a flat plate configuration and being arranged at a center portion of the transparent lens member, wherein the control method comprising:
determining whether image data configuring display image data displayed on the display screen is image data of a target area to be enlarged by the anisotropic magnification lens portion; and
performing, when it is determined by the determining that the image data configuring the display image data displayed on the display screen is the image data of the target area to be enlarged by the anisotropic magnification lens portion, an image size reducing process by using an inverse function of a function configured to enlarge the image data.
